(19) United States
(12) Patent Application Publication
(10) Pub. No.: US 2018/0273051 A1
(43) Pub. Date: Sep. 27, 2018

(54) Controller and Method of Setting an Intervention Zone in a Lane Departure Warning System

(71) Applicant: Bendix Commercial Vehicle Sytems LLC, Elyria, OH (US)

(72) Inventors: William P Amato, Avon, OH (US); Nicholas A Broyles, Elyria, OH (US); Andrew J Pilkington, Avon Lake, OH (US)

(21) Appl. No.: 15/468,320

(22) Filed: Mar. 24, 2017

(51) Int. Cl. B60W 50/14; B60W 30/09; B60W 10/18; B60W 10/20; B60W 30/12

(52) U.S. Cl. CPC B60W 50/14; B60W 30/09; B60W 10/18; B60W 10/20; B60W 30/12; B60W 2050/143; B60W 2550/10; B60W 2420/52; B60W 2050/146; B60W 2422/00; B60W 2710/18; B60W 2710/20; B60W 2420/42

(57) ABSTRACT

A controller for a driver assistance system on a host vehicle comprises an input for receiving a video signal; an input for receiving a signal indicative of an obstacle; an alert output for transmitting an alert; and control logic. The control logic is capable of identifying a lane marker in the video signal; setting a first zone with respect to the lane marker; receiving a signal indicative of an obstacle; setting a second zone with respect to the lane marker in response to the obstacle; and transmitting an alert at the alert output in response to the host vehicle entering the second zone.

### BACKGROUND

The present invention relates to embodiments of a controller and method of setting an intervention zone in a lane departure warning system. A typical lane departure warning system includes a camera for tracking lane markers and an alert system for notifying a driver when he drifts over a lane marker without activating a turning signal. The forward looking camera has a narrow view of the road ahead from its mounting location on the windshield of the vehicle and does not generally detect objects to the sides of the vehicle. A typical side object detection system includes a radar mounted on the side of the vehicle that can detect metallic objects up to about ten feet to the side of the vehicle. In most vehicles, the lane departure warning system and side object detection systems are separate systems operating independently to assist the driver. There is a desire for an improved system for lane departure warning that takes advantage of side object detection capabilities.

### SUMMARY

Various embodiments of a controller for a driver assistance system on a host vehicle comprise an input for receiving a video signal; an input for receiving a signal indicative of an obstacle; an alert output for transmitting an alert; and control logic. The control logic is capable of identifying a lane marker in the video signal; setting a first zone with respect to the lane marker; receiving a signal indicative of an obstacle; setting a second zone with respect to the lane marker in response to the obstacle; and transmitting an alert at the alert output in response to the host vehicle entering the second zone.

In accordance with another aspect, various embodiments of a method for controlling a host vehicle having a driver assistance system comprise identifying a lane marker in response to a video signal and setting a first zone with respect to the lane marker. The method further comprises identifying an obstacle in response to a radar signal; setting a second zone with respect to the lane marker in response to the obstacle detection; determining the host vehicle is entering the second zone; and transmitting an alert in response to the host vehicle entering the second zone.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a system according to one example of the present invention.

FIGS. 2A and 2B illustrate a vehicle on a roadway having a system according to the present invention.

FIG. 3 illustrates a method of operating a lane departure warning system according to the present invention.

### DETAILED DESCRIPTION

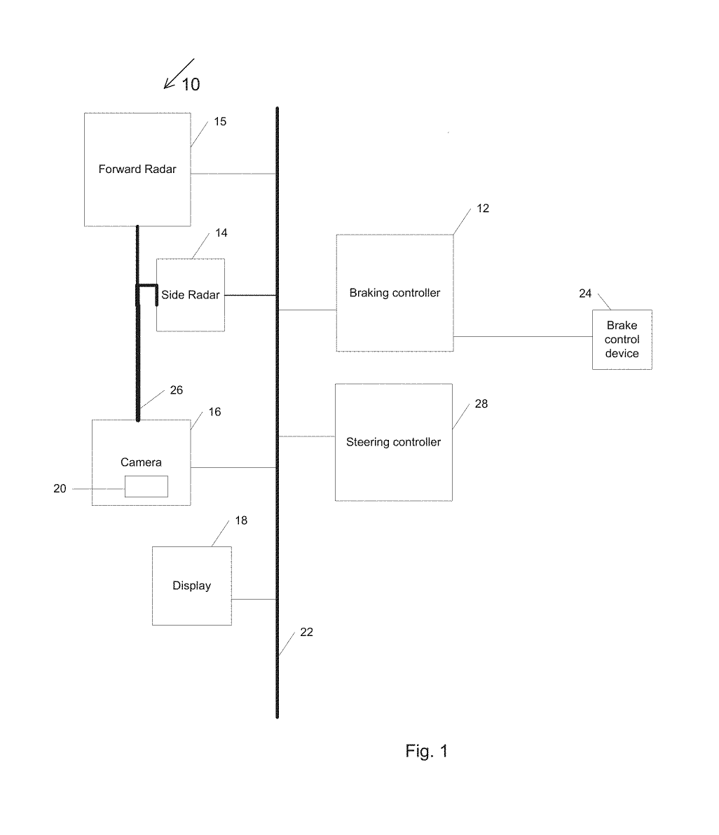

FIG. 1 illustrates a driver assistance system (DAS) 10 for a commercial vehicle according to one example of the present invention. The DAS 10 includes a camera controller 16 for implementing functions of DAS 10. The camera controller 16 includes inputs for receiving video signals to detect lane markings in the field of view of the camera controller 16. The camera controller 16 may be the type as used in an Autovue® Lane Departure Warning System available from Bendix Commercial Vehicle Systems LLC, Elyria Ohio. The camera controller 16 is generally mounted on the windshield of the commercial vehicle. The camera controller 16 may detect dashed lines, solid lines or Botts' dots indicating lane markings or berm markings on a roadway. The camera controller 16 is generally pre-programmed with the width of the commercial vehicle on which the camera controller 16 is mounted.

The DAS 10 includes a side radar controller 14. The side radar controller 14 may be the type as used in the Blindspotter® Side Object Detection System available from Bendix Commercial Vehicle Systems LLC, Elyria Ohio. A side radar controller 14 may be mounted on the passenger side of the commercial vehicle, monitoring a typical vehicle blindspot. A second side radar controller (not shown) may be mounted on the driver side of the commercial vehicle to provide additional monitoring around the vehicle. The side radar controller 14 includes an input for receiving radar signals indicative of metallic objects, such as other vehicles and guard rails, in the field of view of the side radar controller 14. Alternatively, a second camera controller may be used in place of the side radar controller 14 in order to detect objects to the side of the commercial vehicle.

The DAS 10 may include a forward radar controller 15. The forward radar controller 15 receives radar signals indicative of objects to the front of the commercial vehicle and provides functionality such as adaptive cruise control with braking. The forward radar controller 15 may be the type as used in the Wingman® Advanced™ adaptive cruise with braking system available from Bendix Commercial Vehicle Systems LLC, Elyria Ohio.

The camera controller 16 includes a processor with control logic 20 for analyzing video signals and receiving and transmitting messages in response to the analysis of the video signals. The control logic 20 may also perform functions for vehicle control. The control logic 20 may include volatile, non-volatile memory, solid state memory, flash memory, random-access memory (RAM), read-only memory (ROM), electronic erasable programmable read-only memory (EEPROM), variants of the foregoing memory types, combinations thereof, and/or any other type(s) of memory suitable for providing the described functionality and/or storing computer-executable instructions for execution by the control logic 20. Alternatively, the forward radar controller 15 or the side radar controller 14 contain control logic for performing vehicle control in response to video signals or radar signals.

Each of the camera controller 16, the front radar controller 15 and the side radar controller 14 include a communications port for communicating via a proprietary communications bus 26. Each controller is capable of transmitting and receiving messages indicative of lane markers and obstacles. Each of the camera controller 16, front radar controller 15 and the side radar controller 14 include a port for communicating with other controllers on the vehicle via a vehicle serial communications bus 22. The serial communications bus 22 may use the SAE J1939 protocol or other vehicle communications protocol. Alternatively, each controller communicates only with the vehicle serial communications bus 22, eliminating the proprietary communications bus 26.

The DAS 10 may also include a display 18. The display 18 indicates to the driver the status of the DAS 10, including object detection and fault codes. The indication may include audible indicators, visual indicators or a combination of both. The display 18 communicates with the serial communications bus 22 or may be directly connected to the camera controller 16. The display 18 may be dedicated to functions of the DAS 10 or may receive and communicate messages from other vehicle systems when connected to the serial communications bus 22.

The DAS 10 communicates with a brake controller 12 using the serial communications bus 22. The brake controller 12 may automatically perform vehicle control functions in response to the messages received from the DAS 10 and may also perform antilock braking and other braking functions. The brake controller 12 communicates with at least one brake control device 24 to implement braking at each wheel end.

The DAS 10 communicates with a steering system controller 28 using the serial communications bus 22. The steering controller 28 automatically controls the steering to affect the direction in which the vehicle is moving.

Therefore, an apparatus for a controller for a driver assistance system on a host vehicle comprise an input for receiving a video signal; an input for receiving a signal indicative of an obstacle; an alert output for transmitting an alert; and control logic. The control logic is capable of identifying a lane marker in the video signal; setting a first zone with respect to the lane marker; receiving a signal indicative of an obstacle; setting a second zone with respect to the lane marker in response to the obstacle; and transmitting an alert at the alert output in response to the host vehicle entering the second zone.

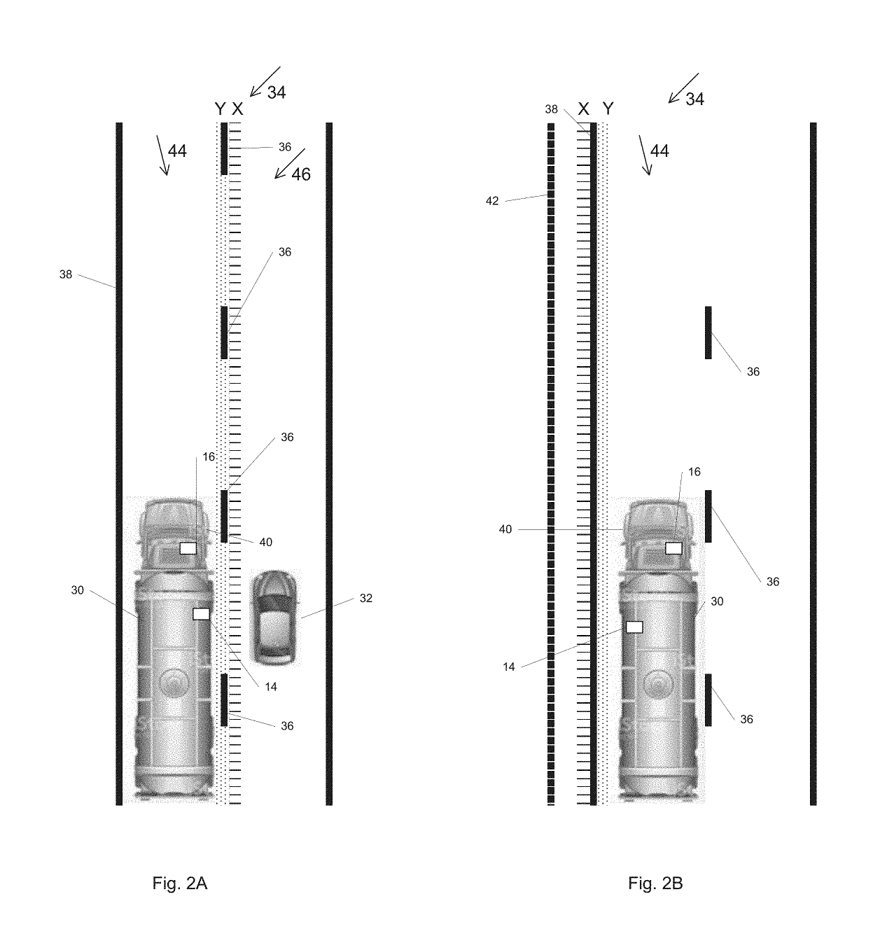

FIG. 2A illustrates a two lane roadway 34 having a host vehicle 30, equipped with the DAS 10, and a target vehicle 32. The host vehicle 30 and the target vehicle 32 are traveling in the same direction on the roadway 34. The host vehicle 30 is traveling in lane 44 and the target vehicle 32 is traveling in lane 46.

In this example, the camera controller 16 detects the center line lane markings 36 between lane 44 and lane 46 and the berm marking 38 according to known operation of the camera controller 16. The markings 36, 38 may be Botts' dots, solid lines or dashed lines. The camera controller 16 sets a first zone X (shown as dashed zones in FIG. 2A) based on the center line lane markings 36. The first zone X may begin at the center line lane markings 36 and extend about six inches to the right of the center line lane markings 36.

Since the camera controller 16 knows the width of the host vehicle 30, the camera controller 16 can approximate the location of a wheel edge 40 of the host vehicle 30. If no target vehicle or other obstacle is detected by the side radar controller 14, the camera controller 16 continues to monitor the motion of the host vehicle 30. When the camera controller 16 determines that the wheel edge 40 of the host vehicle 30 has crossed over the center line lane markings 36 and into the first zone X and no turn signal was enabled, a message will be sent on the vehicle communications bus 22 to the display device 18. The display device 18 will give a visual or audible alert to the driver of the host vehicle 30 so that he can manually return the host vehicle 30 to the lane 44 if he did not intend to travel to the adjacent lane 46.

While the camera controller 16 is monitoring the motion of the host vehicle 30, the side radar controller 14 continues to monitor for obstacles or other vehicles in lane 46. In one example, the side radar controller 14 will detect the target vehicle 32 according to the known operation of the side radar controller 14. The side radar controller 14 determines the lateral distance between the host vehicle 30 and the target vehicle 32. The side radar controller 14 transmits the message indicating the detection and location of the target vehicle 32 to the camera controller 16 via the proprietary communications bus 26.

The control logic 20 of the camera controller 16 then sets a second zone Y (shown as the dotted zone in FIG. 2A). The second zone Y is closer laterally to the host vehicle 30 than the first zone X. In one example, the second zone Y begins at about three inches to the left of the lane markings 36. The second zone Y remains set as long as the target vehicle 32 remains detected by the side radar controller 14.

In another example, the second zone Y may partially overlap the first zone X. In another example, the second zone Y is set according to the lateral distance between the target vehicle 32 and host vehicle 30 and changes according to the detected lateral movement of the target vehicle 32. In another example, the second zone Y is set based on the detected size of the target vehicle 32.

When the wheel edge 40 of the host vehicle 30 crosses into second zone Y, the camera controller 16 transmits a message to the display device 18 regardless of whether the turn signal is enabled. The display 18 transmits a visual or audible alert. In this manner, the driver of the host vehicle 30 receives a prompt warning earlier that he is about to drift into the path of the target vehicle 32. The driver can then make manual adjustments earlier to avoid a collision.

In another example, the camera controller 16 transmits a message to the brake controller 12 when the host vehicle 30 enters the second zone Y. The braking controller 12 will then transmit a signal to the brake control device 24 to automatically initiate braking to avoid a collision. Alternatively, the camera controller 16 transmits the message to the brake controller 12 when the host vehicle 30 leaves the second zone Y and enters the previously set first zone X.

In another example, the camera controller 16 transmits a message to the steering controller 28 when the host vehicle 30 enters the second zone Y. The steering controller 28 will then automatically control the steering to maintain the host vehicle 30 in lane 44. Alternatively, the camera controller 16 transmits the message to the steering controller 28 when the host vehicle 30 leaves the second zone Y and enters the previously set first zone X.

In another example, the camera controller 16 transmits a message to the display 18 and the audible and/or visual signal is modified. In one example, the display 18 may increase the frequency, volume or pitch of the audible signal to indicate a possible collision with the target vehicle 32. In another example, the display 18 may activate a light at a higher frequency to indicate a possible collision with the target vehicle 32. Alternatively, the camera controller 16 transmits the message to modify the alert when the host vehicle 30 leaves the second zone Y and enters the previously set first zone X.

FIG. 2B illustrates the two lane roadway 34 having the host vehicle 30, equipped with the DAS 10. In this example, the host vehicle 30 includes a side radar controller 14 mounted on the driver's side of the host vehicle 30. The camera controller 16 detects the edge of road, or berm markings 38 according to known operation of the camera controller 16. The camera controller 16 sets a first zone X (shown as a dashed zone in FIG. 2B) based on the markings 38. The first zone X may begin at the berm markings 38 and extend about six inches to the left of the berm markings 38.

If no obstacle is detected by the side radar controller 14, when the camera controller 16 indicates that a wheel edge 40 of the host vehicle 30 has crossed over the berm markings 38 into the first zone X, a message will be sent on the vehicle communications bus 22 to the display device 18. The display device 18 will give a visual or audible alert to the driver of the vehicle so that he can return the vehicle to the lane 44.

In this example, the side radar controller 14 will detect the obstacle, such as guard rails 42, to the left of the host vehicle 30, according to the known operation of the side radar controller 14. The side radar controller 14 determines the lateral distance between the host vehicle 30 and the guard rails 42. The side radar controller 14 transmits the message indicating the detection and location of the guard rails 42 to the camera controller 16 via the proprietary communications bus 26.

The control logic 20 of the camera controller 16 sets a second zone Y (shown as a dotted zone in FIG. 2B). The second zone Y begins to the left of the host vehicle 30 and at about six inches to the right of the berm markings 38. The second zone Y remains set as long as the guard rails 42 remain detected by the side radar controller 14.

When a wheel edge 40 of the host vehicle 30 enters into second zone Y, the camera controller 16 transmits a message to the display device 18 regardless of whether the turn signal is enabled. In this manner, the driver of the host vehicle 30 receives a prompt warning earlier that he is about to drift past the berm marking 38 and into the guard rails 42. The driver can then make manual adjustments earlier to avoid a collision.

In another example, the camera controller 16 transmits a message to the brake controller 12 when the wheel edge 40 of the host vehicle 30 enters the second zone Y. The braking controller 12 will then transmit a signal to the brake control device 24 to automatically initiate braking to avoid a collision. Alternatively, the camera controller 16 transmits the message to the brake controller 12 when the host vehicle 30 leaves the second zone Y and enters the previously set first zone X.

In another example, the camera controller 16 transmits a message to the steering controller 28 when the host vehicle 30 enters the second zone Y. The steering controller 28 will then automatically control the steering to maintain the host vehicle 30 in lane 44. Alternatively, the camera controller 16 transmits the message to the steering controller 28 when the host vehicle 30 leaves the second zone Y and enters the previously set first zone X.

In another example, the camera controller 16 transmits a message to the display 18 and the audible and/or visual signal is modified. In one example, the display 18 may increase the frequency of the audible signal to indicate a possible collision. In another example, the display 18 may blink a light at a higher frequency to indicate a possible collision. Alternatively, the camera controller 16 transmits the message to modify the alert when the host vehicle 30 leaves the second zone Y and enters the previously set first zone X.

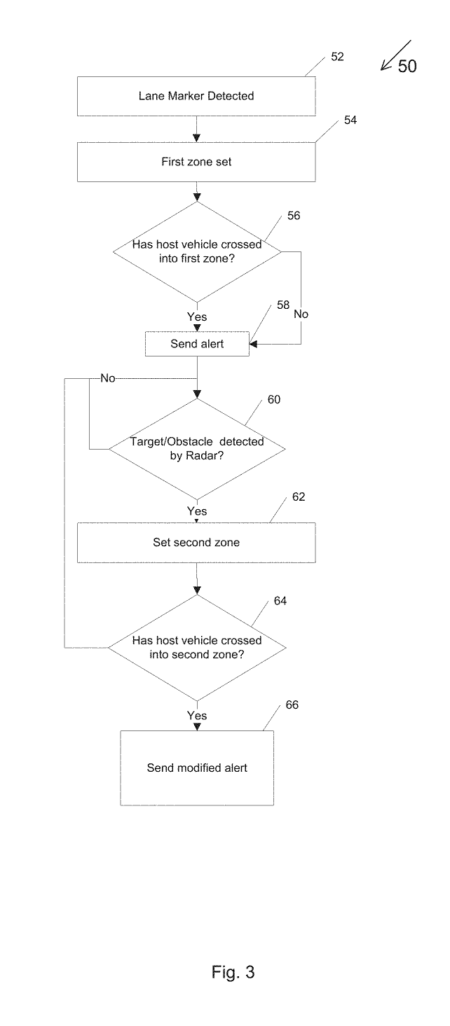

FIG. 3 illustrates a method 50 of setting zones for different types of interventions according to one example of the invention. In step 52, the camera controller 16 identifies the lane markers 36. In step 54, the first zone X is set by the DAS 10 based on the lane markers 36. The control steps of the method 50 as executed by the DAS 10 can take place in the camera controller 16, the forward radar controller 15, the side radar controller 14 or any combination thereof.

In step 56, the DAS 10 determines if the host vehicle is moving into the first zone X. If the host vehicle is moving into the first zone X without activating a turn signal, then an alert is transmitted to the display in step 58. The alert may be a visual or audible alert for the driver. The method 50 continues to step 60. If the host vehicle is not moving into the first zone X, then the method 50 continues directly to step 60.

In step 60, the DAS 10 determines if an obstacle or target vehicle has been detected by the side radar controller 14. If a target vehicle or obstacle has been detected, then the method 50 continues to step 62. Otherwise, the method 50 remains at step 60.

In step 62, the DAS 10 sets a second zone Y in response to the detection of a target and the lane markings. The second zone Y is laterally closer to the host vehicle than the first zone X.

In step 64, the DAS 10 determines if the wheel edge of the host vehicle has crossed into the second zone Y. If yes, then in step 66, a modified alert is transmitted by the DAS 10. The modified alert may be an audible or visual signal differing in frequency and intensity from the first alert. In another example, the DAS 10 transmits a control message to the brake controller 12. In another example, the DAS 10 transmits a control message to the steering controller 28.

Therefore, a method for controlling a host vehicle having a driver assistance system comprise identifying a lane marker in response to a video signal and setting a first zone with respect to the lane marker. The method further comprises identifying an obstacle in response to a radar signal; setting a second zone with respect to the lane marker in response to the obstacle detection; determining the host vehicle is entering the second zone; and transmitting an alert in response to the host vehicle entering the second zone.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

We claim:

1. A controller for a driver assistance system on a host vehicle comprising:
an input for receiving a video signal;
an input for receiving a signal indicative of an obstacle;
an output for transmitting an alert; and
control logic, the control logic capable of:
identifying a lane marker in the video signal;
setting a first zone with respect to the lane marker;
receiving a signal indicative of an obstacle;
setting a second zone with respect to the lane marker in response to the obstacle; and
transmitting an alert at the output in response to the host vehicle entering the second zone.

2. The controller as in claim 1, wherein the controller transmits an alert in response to the host vehicle entering the first zone, wherein the alert for the first zone is different than the alert transmitted when the host vehicle enters the second zone.

3. The controller as in claim 1, wherein the host vehicle enters the second zone by moving in a direction toward the identified lane marker and the identified obstacle.

4. The controller as in claim 1, wherein the identified obstacle is a vehicle traveling in a lane adjacent to the host vehicle.

5. The controller as in claim 1, wherein the signal indicative of an obstacle is received from a sensor mounted on a side of the host vehicle.

6. The controller as in claim 1, further comprising: an output for transmitting a braking control signal; wherein the control logic transmits the braking control signal in response to the host vehicle entering the second zone.

7. The controller as in claim 1, further comprising: an output for transmitting a steering control signal; wherein the control logic transmits the steering control signal in response to the host vehicle entering the second zone.

8. The controller as in claim 1, wherein transmitting an alert includes setting an audible signal in response to the host vehicle entering the second zone.

9. The controller as in claim 8, wherein the audible signal changes in at least one of pitch and frequency in response to the host vehicle entering the second zone.

10. The controller as in claim 1, wherein the second zone is laterally closer to the host vehicle than the first zone.

11. The controller as in claim 1, wherein the host vehicle enters the first zone when the wheel edge is beyond the identified lane marker and the host vehicle enters the second zone when the wheel edge is about three inches to the left of the identified lane marker.

12. The controller as in claim 1, wherein the identified lane marker is at least one of solid lines, Botts' dots and dashed lines.

13. The controller as in claim 1, wherein the second zone remains set as long as the obstacle is detected.

14. A driver assistance system on a host vehicle comprising:
a radar controller for identifying a target vehicle;
a camera controller for identifying the lane marker; wherein at least one of the radar controller and the camera controller is capable of:
identifying a lane marker in the field of view of the camera controller;
setting a first zone with respect to the lane marker;
identifying an obstacle in the field of view of the radar controller;
setting a second zone with respect to the lane marker in response to the obstacle being detected; and
transmitting an alert at the alert output in response to the host vehicle entering the second zone.

15. The driver assistance system as in claim 14, further comprising a display for indicating the presence of the obstacle and a status of the alert output.

16. The driver assistance system as in claim 14, wherein the at least one of the radar controller and the camera controller transmits an alert in response to the host vehicle entering the first zone, wherein the alert for the host vehicle entering the first zone is different than the alert transmitted when the host vehicle enters the second zone.

17. A method for controlling a host vehicle having a driver assistance system comprising:
identifying a lane marker in response to a video signal;
setting a first zone with respect to the lane marker;
identifying an obstacle in response to a radar signal;
setting a second zone with respect to the lane marker in response to the obstacle detection;
determining the host vehicle is entering the second zone; and
transmitting an alert in response to the host vehicle entering the second zone.

18. The method as in claim 17, further comprising autonomously applying the service brakes in response to the host vehicle entering the second zone.

19. The method as in claim 17, further comprising autonomously steering the host vehicle in response to the host vehicle entering the second zone.

20. The method as in claim 17, wherein determining the first zone and the second zone comprises using a sensor mounted on the side of the host vehicle.

21. The method as in claim 17, further comprising transmitting an alert in response to the host vehicle entering the first zone, wherein the alert for the host vehicle entering the first zone is different than the alert transmitted when the host vehicle enters the second zone.
